(19) United States
(12) Patent Application Publication
(10) Pub. No.: US 2019/0101879 A1
(43) Pub. Date: Apr. 4, 2019

(54) Power Aware Techniques For Energy Harvesting Remote Sensor Systems

(71) Applicant: Lockheed Martin Corporation, Bethesda, MD (US)

(72) Inventors: Ertugrul Berkcan, Clifton Park, NY (US); Emad Andarawis, Ballston Lake, NY (US); Eladio Delgado, Burnt Hills, NY (US); Samantha Rao, Bangalore (IN)

(73) Assignee: Lockheed Martin Corporation, Bethesda, MD (US)

(21) Appl. No.: 16/135,935

(22) Filed: Sep. 19, 2018

Related U.S. Application Data
(62) Division of application No. 12/208,222, filed on Sep. 10, 2008, now abandoned.

(51) Int. Cl. G05B 19/042

(52) U.S. Cl. CPC G05B 19/042; G05B 2219/23316

(57) ABSTRACT

A monitoring system for an aircraft.

### RELATED APPLICATIONS

This application is a divisional of and claims priority to and the benefit of U.S. Non-Provisional patent application Ser. No. 12/208,222, filed on Sep. 10, 2008, the disclosure of which is incorporated herein in its entirety.

### BACKGROUND

This disclosure relates to monitoring systems for aircraft.

### BRIEF DESCRIPTION OF THE DRAWINGS

FIG. 1 is an illustration of an exemplary embodiment of an aircraft monitoring system.

FIG. 2 is a schematic illustration of the aircraft monitoring system of FIG. 1.

FIG. 3 is a schematic illustration of an exemplary embodiment of sensor nodes of the aircraft monitoring system of FIG. 2.

FIGS. 4a and 4b are flow chart illustrations of an exemplary embodiment of a method of operating the sensor nodes of FIG. 3.

FIGS. 5a and 5b are flow chart illustrations of an exemplary embodiment of a method of operating the sensor nodes of FIG. 3.

FIG. 6 is a schematic illustration of an exemplary embodiment of an aircraft monitoring system.

FIG. 7 is a schematic illustration of an exemplary embodiment of an aircraft monitoring system.

FIG. 8 is a flow chart illustration of a method of operating an aircraft monitoring system.

### DETAILED DESCRIPTION

In the drawings and description that follows, like parts are marked throughout the specification and drawings with the same reference numerals, respectively. The drawings are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

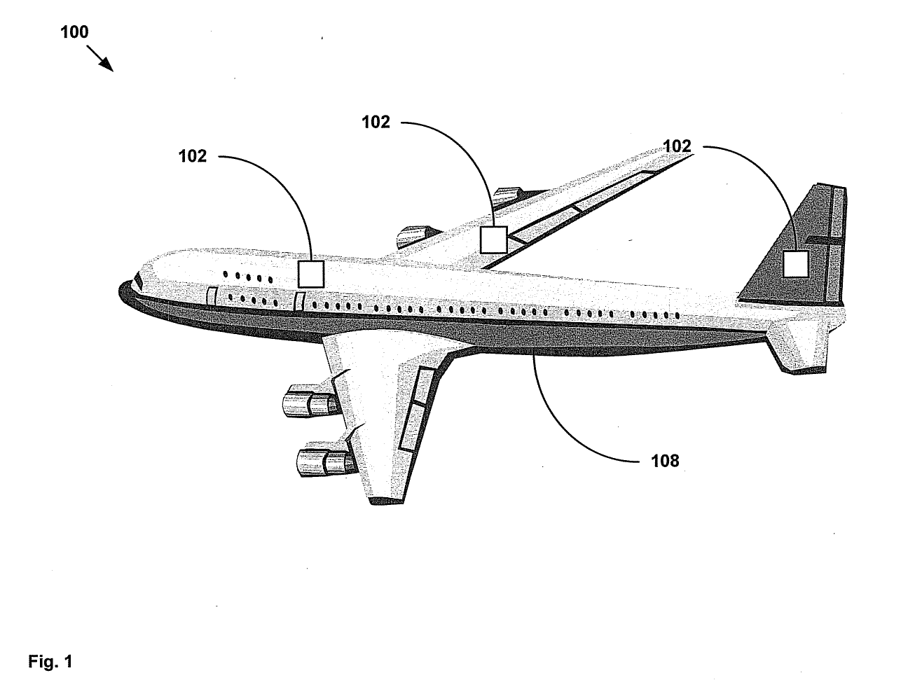

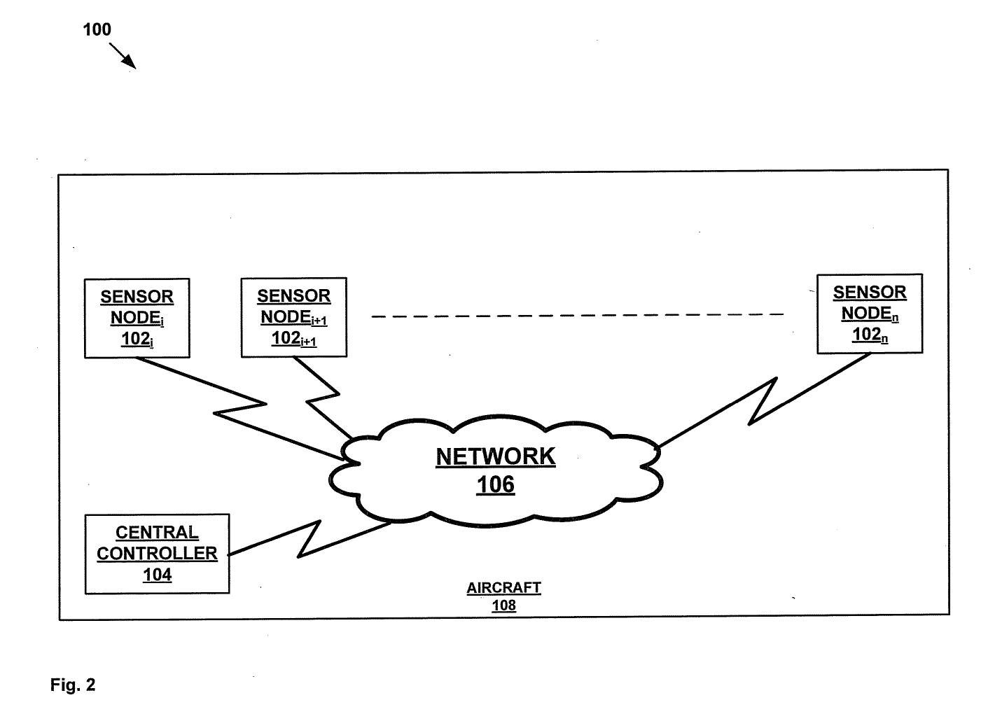

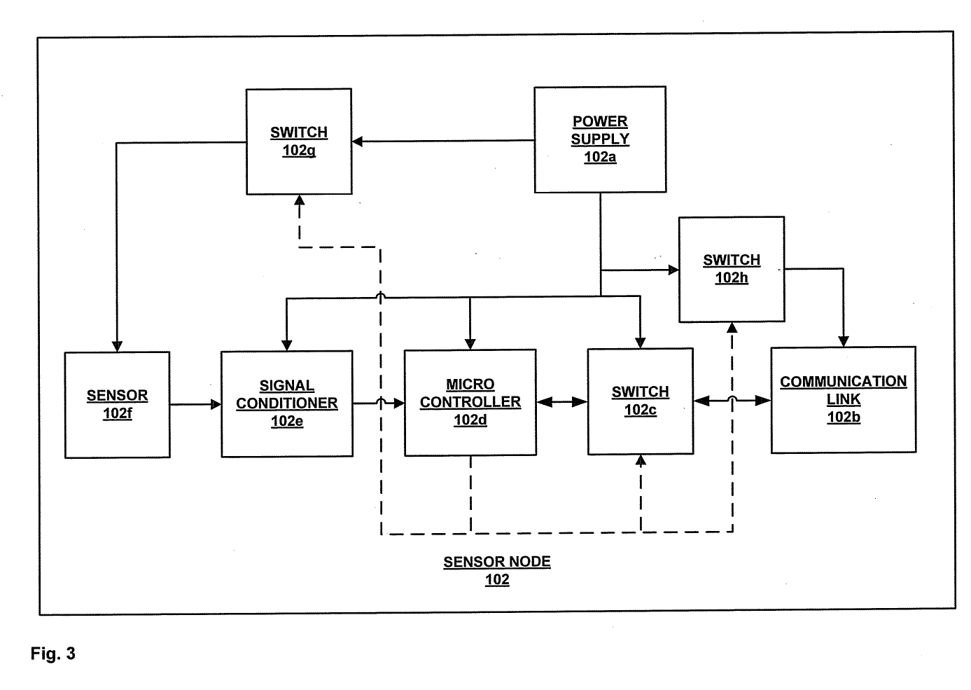

Referring to FIGS. 1-3, an exemplary embodiment of a system 100 for monitoring an aircraft includes one or more sensors nodes 102 that are operably coupled to a central controller 104 by a network 106. In an exemplary embodiment, the sensor nodes 102 are distributed within an aircraft 108 for monitoring one or more operational states of the aircraft that may, for example, include stresses, strains, temperatures, and pressures. In an exemplary embodiment, one or more of the sensor nodes 102 communicate the operational states of the aircraft 108 to the central controller 106 that is housed within the aircraft using, for example, a network 106 that may, for example, include a hard wired, fiber optic, infra red, radio frequency, or other communication pathway.

In an exemplary embodiment, each sensor node 102 includes a power supply 102a that is adapted to scavange energy from the immediate environment. In an exemplary embodiment, the power supply 102a may, for example, scavenge electromagnetic energy, vibrational energy, heat energy, and/or wind energy from the immediate environment. In an exemplary embodiment, the power supply 102a is operably coupled, and supplies power, to a communication link 102b, a switch 102c, a micro-controller 102d, a signal conditioner 102e, a sensor 102f, a switch 102g, and a switch 102h.

In an exemplary embodiment, the communication link 102b is also operably coupled to the switch 102c and adapted to transmit and receive communication signals between the sensor node 102 and the network 106. In this manner, the sensor node 102 may communicate with other sensor nodes and the central controller 104.

In an exemplary embodiment, the switch 102c is also operably coupled to the communication link 102b and the micro-controller 102d and adapted to be controlled by the micro-controller to thereby communications between the communication link and the micro-controller. In this manner, in the event that the micro-controller 102d determines that communication should not occur between the communication link 102b and the micro-controller such as, for example, if the sensor node 102 lacks sufficient power, the micro-controller may operate the switch to prevent communication between the communication link and the micro-controller. In an exemplary embodiment, the switch 102c may, for example, be a mechanical, electrical, or a logical switch.

In an exemplary embodiment, the micro-controller 102d is also operably coupled to the communication link 102b, the switch 102c, the signal conditioner 102e, the sensor 102f, and the switch 102g for monitoring and controlling the operation of each. In an exemplary embodiment, the micro-controller 102d may include, for example, a conventional general purpose programmable controller.

In an exemplary embodiment, the signal conditioner 102e is also operably coupled to the micro-controller 102d and the sensor 102 and adapted to condition signals transmitted by the sensor before they are further processed by the micro-controller. In an exemplary embodiment, the signal conditioner 102e may, for example, include one or more conventional signal processing elements such as, for example, filters, amplifiers, and analog to digital converters.

In an exemplary embodiment, the sensor 102f is also operably coupled to the signal conditioner 102e and the switch 102g and adapted to sense one or more operating conditions of the aircraft 108 in the immediate environment. In an exemplary embodiment, the sensor 102f may include, for example, one or more of the following: a strain gauge, a stress sensor, a temperature gauge, a pressure gauge, an radiation detector, a radar detector, and/or a detector of electromagnetic energy.

In an exemplary embodiment, the switch 102g is also operably coupled to the micro-controller 102d and the sensor 102f and adapted to control the operation of the sensor under the controller of the micro-controller. In this manner, in the event that the micro-controller 102d determines that the sensor 102f should not operate such as, for example, if the sensor node 102 lacks sufficient power, the micro-controller may operate the switch 102g to prevent power from being supplied by the power supply 102a to the sensor.

In an exemplary embodiment, the switch 102h is also operably coupled to the micro-controller 102d and the communication link 102b and adapted to control the operation of the communication link under the controller of the micro-controller. In this manner, in the event that the micro-controller 102d determines that the communication link 102b should not operate such as, for example, if the sensor node 102 lacks sufficient power, the micro-controller may operate the switch 102h to prevent power from being supplied by the power supply 102a to the communication link.

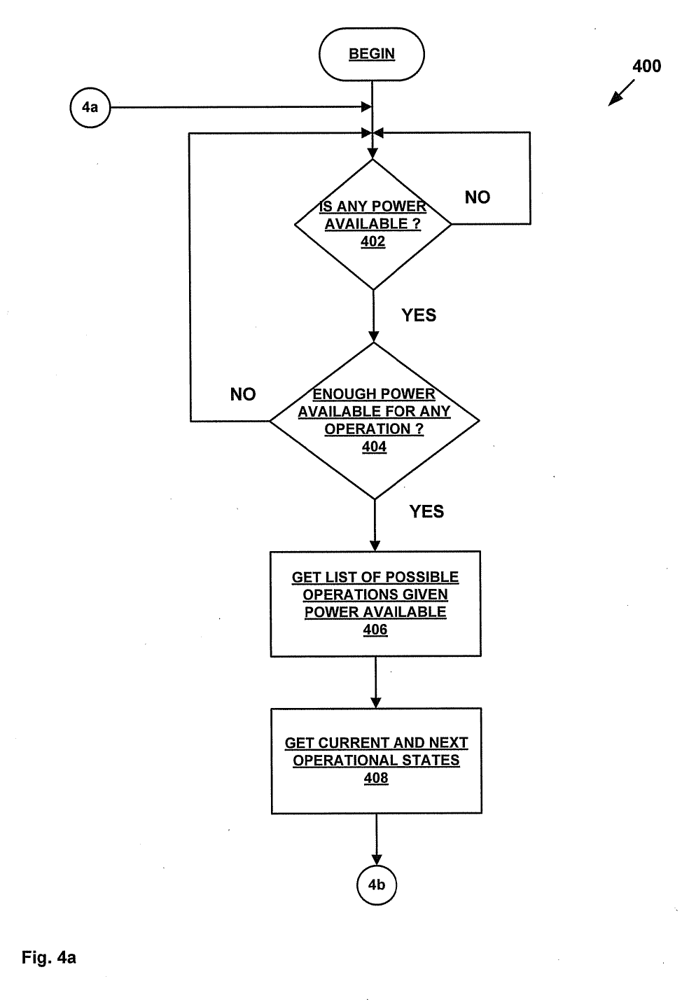

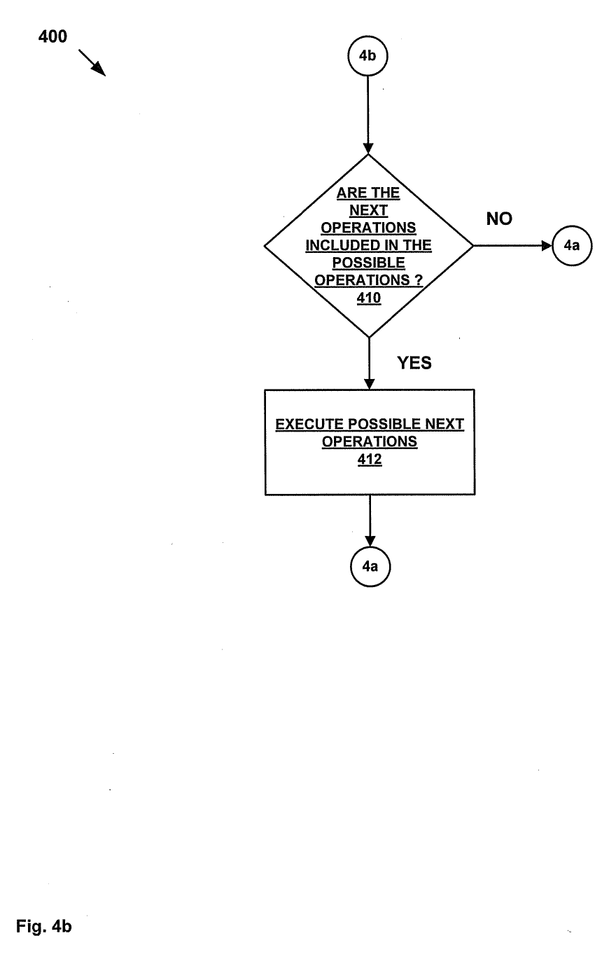

Referring now to FIGS. 4a and 4b, in an exemplary embodiment, one or more of the sensor nodes 102 of the system 100 implement a method 400 of operating in which, in 402, the sensor node determines if there is any power available to the sensor node. If there is any power available to the sensor node 102, then the sensor node determines if there is enough power available to the sensor node to permit the sensor node to execute at least one operation in 404.

If there is enough power available to permit the sensor node 102 to execute at least one operation, then the sensor gets a listing of the possible operations given the amount of available power in 406. The sensor node 102 then gets a listing of the current and next operational states for the sensor node in 408.

The sensor node 102 then determines if the next operational states of the sensor node are included in the possible operations given the amount of available power in 410. If the next operational states of the sensor node 102 are included in the possible operations given the amount of available power, then the sensor node executes the next operational states that are possible to execute given the amount of available power in 412.

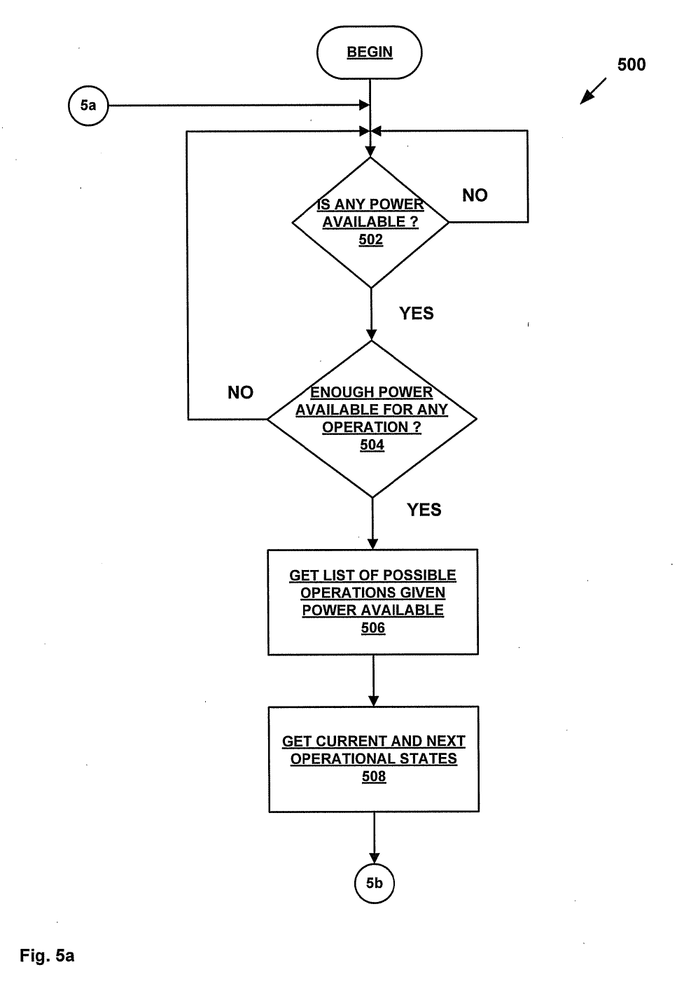

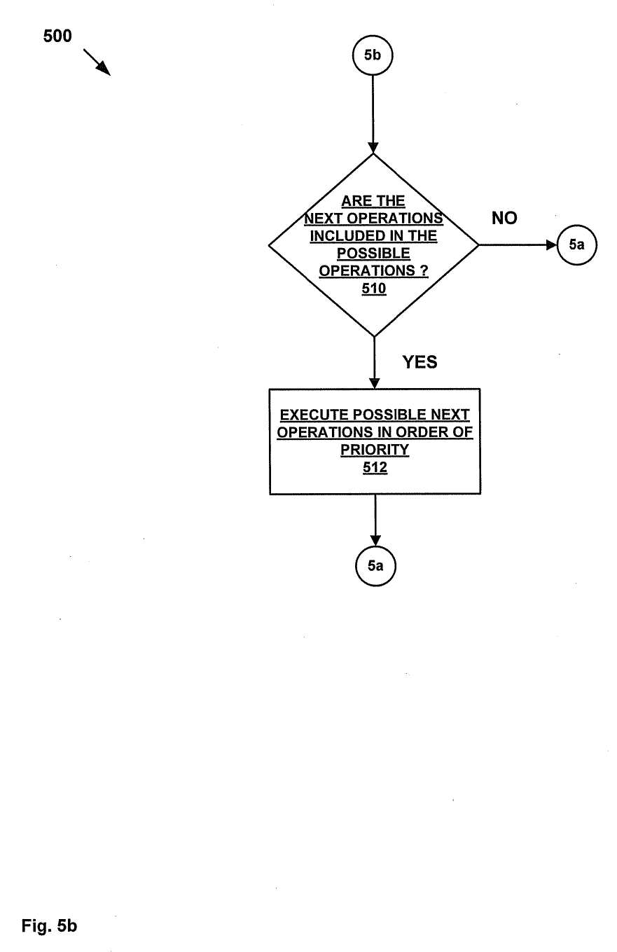

Referring now to FIGS. 5a and 5b, in an exemplary embodiment, one or more of the sensor nodes 102 of the system 100 implement a method 500 of operating in which, in 502, the sensor node determines if there is any power available to the sensor node. If there is any power available to the sensor node 102, then the sensor node determines if there is enough power available to the sensor node to permit the sensor node to execute at least one operation in 504.

If there is enough power available to permit the sensor node 102 to execute at least one operation, then the sensor gets a listing of the possible operations given the amount of available power in 506. The sensor node 102 then gets a listing of the current and next operational states for the sensor node in 508.

The sensor node 102 then determines if the next operational states of the sensor node are included in the possible operations given the amount of available power in 510. If the next operational states of the sensor node 102 are included in the possible operations given the amount of available power, then the sensor node executes the next operational states, based upon their pre-determined priority, that are possible to execute given the amount of available power in 512.

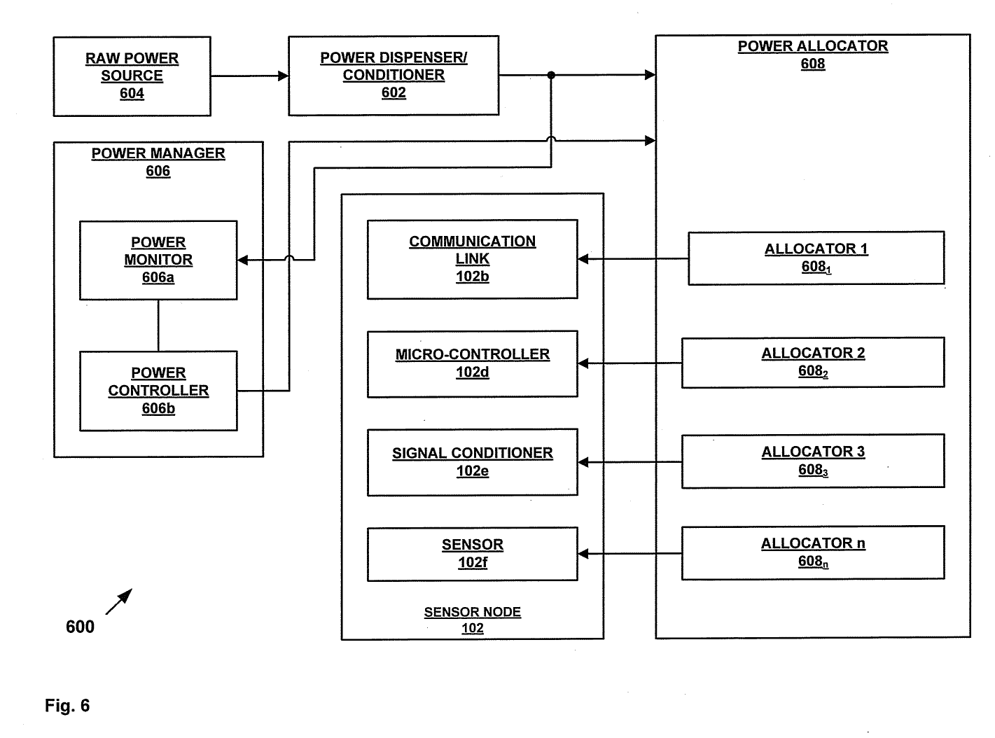

Referring now to FIG. 6, an exemplary embodiment of a system 600 for monitoring an aircraft is substantially identical in design and operation as the system 100 with the addition of a power dispenser and conditioner 602 that is operably coupled to a source of raw power 604, a power manager 606, a power allocator 608.

In an exemplary embodiment, the source of raw power 608 may include one or more of the power supplies 102a of one or more of the sensor nodes 102. In an exemplary embodiment, the power dispenser and conditioner 602 is adapted to receive time varying raw power, P(t)_{raw}, from the source of raw power 604, condition the raw power, and then transmit time varying available power, P(t)ₐᵥₐᵢₗ, to the power allocator 608. In an exemplary embodiment, the power dispenser and conditioner 602 includes one or more elements for conditioning the raw power such as, for example, a rectifier and a filter.

In an exemplary embodiment, the power manager 606 includes a power monitor 606a and a power controller 606b. In an exemplary embodiment, the power monitor 606a is operably coupled to the output of the power dispenser and conditioner 602 for monitoring the available power, P(t)ₐᵥₐᵢₗ. In an exemplary embodiment, the power monitor 606a is also operably coupled to the power controller 606b for communicating the available power, P(t)ₐᵥₐᵢₗ, to the power controller. In an exemplary embodiment, the power controller 606b is also operably coupled to the power allocator 608 for controlling the operation of the power allocator.

In an exemplary embodiment, the power allocator 608 includes one or more allocators 608i that are each coupled to one or more elements of the sensor node 102 for controllably supplying power to the corresponding elements of the sensor node. In this manner, the power manager 606 and the power allocator 608 collectively determine the power available to the sensor node 102 and then allocate the available power to the elements of the sensor node.

In an exemplary embodiment, the system 600 may implement one or more aspects of the methods 400 and 500, described and illustrated above with reference to FIGS. 4a, 4b, 5a, and 5b. In an exemplary embodiment, the elements and functionality of the power dispenser and conditioner 602, the raw power source 604, the power manager 606, and the power allocator 608 may be provided within one or more of the sensor nodes 102 and/or provided within the central controller 104.

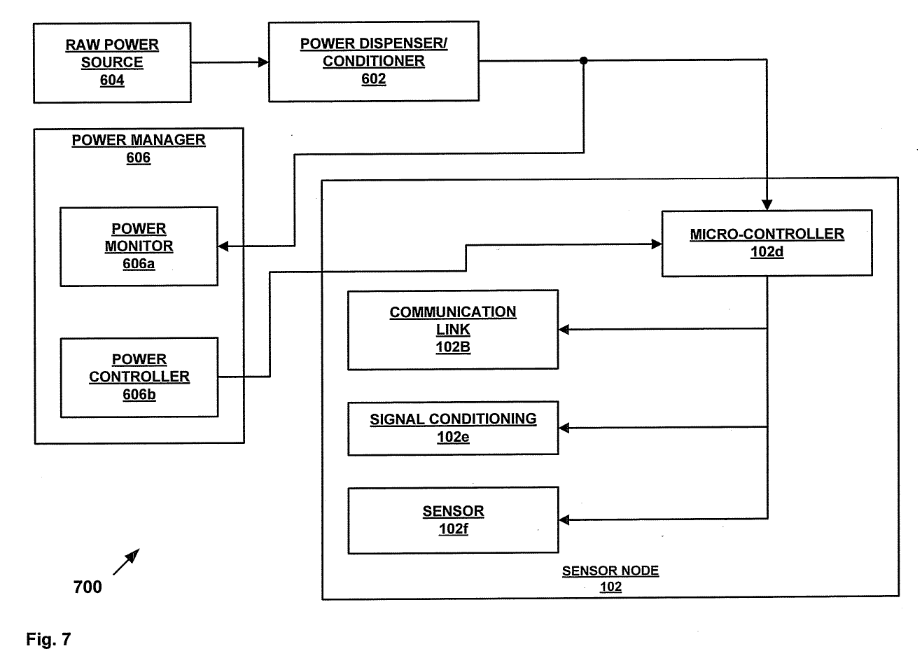

Referring now to FIG. 7, an exemplary embodiment of a system 700 for monitoring an aircraft is substantially identical in design and operation as the system 600 except that the power allocator 608 is omitted and the functionality formerly provided by the power allocator is provided by the micro-controller 102d within the sensor nodes 102.

In particular, in the system 700, the power controller 606b is operably coupled to the micro-controller 102d of the sensor node 102 for directing the allocation of the available power by the micro-controller to the elements of the sensor node.

In an exemplary embodiment, the system 700 may implement one or more aspects of the methods 400 and 500, described and illustrated above with reference to FIGS. 4a, 4b, 5a, and 5b. In an exemplary embodiment, the elements and functionality of the power dispenser and conditioner 602, the raw power source 604, and the power manager 606 may be provided within one or more of the sensor nodes 102 and/or provided within the central controller 104.

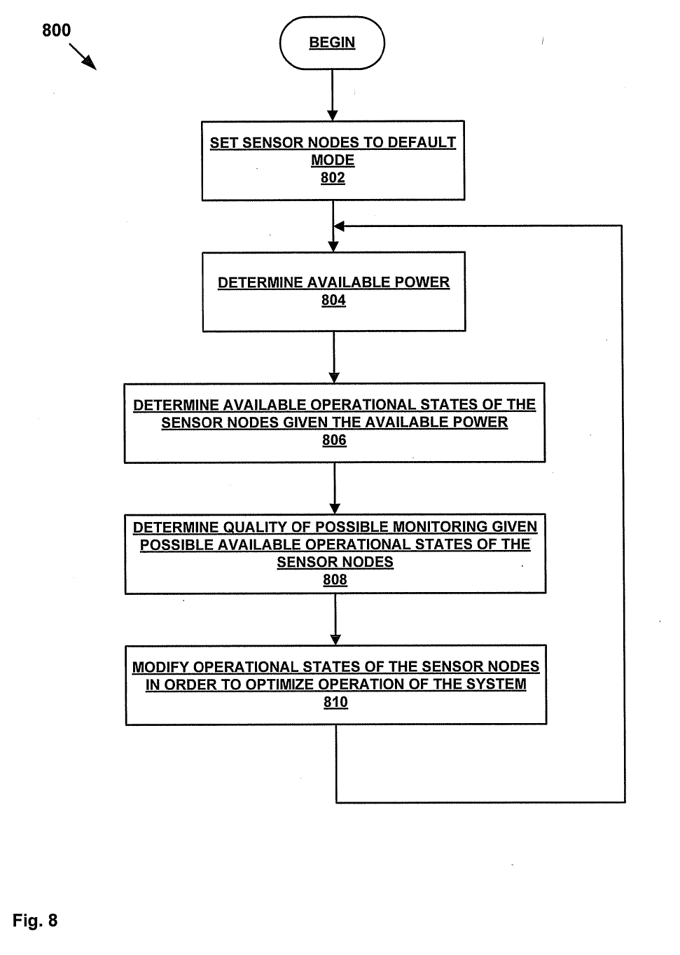

Referring now to FIG. 8, in an exemplary embodiment, one or more of the systems 100, 600, and 700 may implement a method 800 of operating in which, in 802, the sensor nodes 102 are placed into a default mode of operation which may, for example, include a sleep mode in which the sensor node is inactive, a fully active mode in which the sensor node is fully active, or one or more intermediate active modes in which the sensor node has functionality that is less than in the fully active mode. In 804, the system, 100, 600, or 700, will then determine the amount of power available to the system. In an exemplary embodiment, in 806, the system, 100, 600, or 700, will then determine the available operational states of the sensor nodes 102 of the system given the amount of power available to the system.

In an exemplary embodiment, in 808, the system, 100, 600, or 700, will then determine the quality of the possible monitoring of the aircraft 108 given the available operational states of the sensor nodes 102 of the system given the amount of power available to the system. In an exemplary embodiment, the quality of the possible monitoring of the aircraft 108 may be a function of what monitoring is adequate based upon the operating envelope and actual operating condition of the aircraft. For example, when the aircraft 108 is cruising at high altitudes with minimal turbulence, the level of detail and sampling rate in the monitored conditions may be less than when the aircraft is climbing to, or diving from, altitude with heavy turbulence.

In an exemplary embodiment, in 810, the system, 100, 600, or 700, will then modify the operational states of the sensor nodes 102 in order to optimize one or more of: 1) the available operational states of the sensor nodes, 2) the volume of data collected by the sensor nodes, 3) the sampling rate of the data collected by the sensor nodes, 4) the communication throughput of data within the network 106, and/or 5) the quality of the possible monitoring.

In an exemplary embodiment, during the operation of the systems, 100, 600 and/or 700, the switches, 102c, 102g and 102h, may be operated by the micro-controller 102d to place the sensor node 102 in a sleep mode by not permitting operation of the communication link 102b and the sensor 102f. In this manner, the use of power by the sensor node 102 is minimized.

In an exemplary embodiment, during the operation of the systems, 100, 600 and/or 700, the sensor node 102 may be operated in a sleep mode of operation that may, for example, include a range of sleeping mode that may vary from a deep sleep to a light sleep. In an exemplary embodiment, in a deep sleep mode of operation, the sensor node 102 may be completely asleep and then may be awakened by a watch dog timer, or other alert. In an exemplary embodiment, in a light sleep mode of operation, some of the functionality of the sensor node 102 may be reduced. In an exemplary embodiment, in one or more intermediate sleeping modes of operation, the functionality of the sensor node 102 will range from a standby mode, to a light sleep, to a deep sleep.

In an exemplary embodiment, in one or more of the systems 100, 600 and 700, one or more of the elements and functionality of the power dispenser and conditioner 602, the raw power source 604, the power manager 606, and the power allocator 608 may be provided within a sensor node 102, within one or more groups of sensor nodes, and/or within the central controller 104.

In an exemplary embodiment, in one or more of the systems, 100, 600 and 700, one or more of the elements and functionality of the raw power source 604 may be provided within a single sensor node 102, within one or more groups of sensor nodes, or by all of the sensor nodes. For example, if the power supply 102a in each of the sensor nodes 102 within one of the systems, 100, 600 or 700, is a solar cell, then the level of solar energy at each sensor node 102 will vary as a function of its location on the aircraft 108. In an exemplary embodiment, the allocation of power within the sensor nodes 102 of the systems, 100, 600 and 700, will determine the mapping of the power generated by the sensor nodes and then allocate power among the sensor nodes in order to optimize the operation of the systems in monitoring the aircraft 108.

In an exemplary embodiment, in one or more of the systems 100, 600 and 700, one or more of the sensor nodes 102 may provide one or more of the elements and functionality of the central controller 104.

In an exemplary embodiment, one or more of the systems 100, 600 and 700, may be operated to provide an optimal quality of the possible monitoring of the aircraft 108 by placing one or more determined sensor nodes 102 into a sleep mode, even in the presence of adequate power to operate the determined sensor nodes if the systems determine that the optimal quality of the possible monitoring of the aircraft can still be achieved. In this manner, the determined sensor nodes 102 placed into a sleep mode may do one or more of: store power or store data within the determined sensor node. In this manner, data may be warehoused within a sensor node 102 for later use and/or power may be stored within the sensor node for later use.

In an exemplary embodiment, one or more of the systems 100, 600 and 700, may be operated to place one or more determined sensor nodes 102 into a sleep mode if the data for the determined sensor node may be extrapolated using the data available for adjacent sensor nodes.

It is understood that variations may be made in the above without departing from the scope of the invention. While specific embodiments have been shown and described, modifications can be made by one skilled in the art without departing from the spirit or teaching of this invention. The embodiments as described are exemplary only and are not limiting. Many variations and modifications are possible and are within the scope of the invention. Accordingly, the scope of protection is not limited to the embodiments described, but is only limited by the claims that follow, the scope of which shall include all equivalents of the subject matter of the claims.

1. A method for monitoring operational conditions of an aerodynamic structure, the method comprising:
harvesting energy from an immediate environment around the aerodynamic structure;
converting the harvested energy into a time varying raw power;
conditioning the time varying raw power to produce a time varying available power;
monitoring the time varying available power to determine whether the time varying available power is sufficient for executing at least one operation at a sensor node located around the aerodynamic structure;
producing a listing of the at least one operation, given that the time varying available power is sufficient for executing the at least one operation;
assessing at least one next possible operation of the sensor node, given that the time varying available power is sufficient for executing the at least one operation;
determining whether the at least one next possible operation is included in the listing of the at least one operation;
establishing a priority order for executing the at least one next possible operation, given that the at least one next possible operation is included in the listing of the at least one operation;
allocating the time varying available power such that the sensor node has sufficient power to execute a top priority next possible operation, the top priority next possible operation being pursuant to the priority order for executing the at least one next possible operation; and
executing the top priority next possible operation, given that the time varying available power is allocated to the sensor node.

2. The method of claim 1, wherein the energy is selected from the group consisting of: electromagnetic energy, vibrational energy, heat energy, wind energy, and combinations thereof.

3. The method of claim 1, wherein the sensor node is configured to monitor one selected from the group consisting of: stress, strain, temperature, pressure, and combinations thereof.

4. The method of claim 1, further comprising:
placing the sensor node in an operational state selected from the group consisting of: a sleep mode, a fully active mode, and at least one intermediate active mode.

5. The method of claim 1, further comprising:
optimizing one selected from the group consisting of: available operational states of the sensor node, volume of data collected by the sensor node, sampling rate of data collected by the sensor node, communication throughput of data, quality of possible monitoring, and combinations thereof.

6. A system for monitoring operational conditions of an aerodynamic structure, the system comprising:
an energy harvesting component that selectively harvests energy from an immediate environment around the aerodynamic structure;
a power dispenser and conditioner, the power dispenser and conditioner coupled to the energy harvesting component;
a power manager, the power manager coupled to the power dispenser and conditioner;
a power allocator, the power allocator coupled to the power dispenser and conditioner and the power manager;
a sensor node, the sensor node coupled to the aerodynamic structure and the power allocator; and
a means for determining if the amount of harvested energy is sufficient for executing at least one operation at the sensor node, preventing the supply of energy to the sensor node if the harvested energy is insufficient for executing the at least one operation, and energizing the sensor node if the harvested energy is sufficient for executing the at least one operation.

7. The system of claim 6, wherein the energy is selected from the group consisting of: electromagnetic energy, vibrational energy, heat energy, wind energy, and combinations thereof.

8. The system of claim 6, wherein the sensor node is configured to monitor one selected from the group consisting of: stress, strain, temperature, pressure, and combinations thereof.

9. The system of claim 6, wherein the sensor node is placed in an operational state selected from the group consisting of: a sleep mode, a fully active mode, and at least one intermediate active mode.

10. The system of claim 6, wherein the system further comprises a means for optimizing one selected from the group consisting of: available operational states of the sensor node, volume of data collected by the sensor node, sampling rate of data collected by the sensor node, communication throughput of data, quality of possible monitoring, and combinations thereof.

11. The system of claim 6, wherein the power manager comprises:
a power monitor; and
a power controller.

12. The system of claim 11, wherein the power monitor has a means for monitoring the amount of harvested energy.

13. The system of claim 11, wherein the power monitor has a means for determining if the amount of harvested energy is sufficient for executing the at least one operation at the sensor node.

14. The system of claim 11, wherein the power controller has a means for controlling the power allocator.

15. The system of claim 6, wherein the power dispenser and conditioner includes one selected from the group consisting of: a rectifier, a filter, and combinations thereof.

16. The system of claim 6, wherein the power allocator has a means for preventing the supply of energy to the sensor node if the harvested energy is insufficient for executing the at least one operation.

17. The system of claim 6, wherein the power allocator has a means for energizing the sensor node if the harvested energy is sufficient for executing the at least one operation.
